(19) United States
(12) Patent Application Publication
(10) Pub. No.: US 2013/0090059 A1
(43) Pub. Date: Apr. 11, 2013

(54) IDENTITY VERIFICATION

(71) Applicant: Intercede Limited, Lutterworth (GB)

(72) Inventor: Christopher Paul Edwards, Lutterworth (GB)

(73) Assignee: INTERCEDE LIMITED, Lutterworth (GB)

(21) Appl. No.: 13/648,469

(22) Filed: Oct. 10, 2012

(30) Foreign Application Priority Data
Oct. 10, 2011 (GB) 1117449.7

(51) Int. Cl. H04B 5/00

(52) U.S. Cl. 455/41.1

(57) ABSTRACT

Methods and devices for providing verifiable identity information using a mobile device, the method comprising receiving a challenge value, from a guard device, at the mobile device, generating a response value based on the challenge value and a private key associated with the mobile device, and providing the response value and identity information to the guard device.

### CROSS REFERENCE TO RELATED APPLICATION

This application is a non-provisional application claiming priority from GB Patent Application No. 1117449.7, filed Oct. 10, 2011, and incorporated herein by reference in its entirety.

### BACKGROUND

People are regularly asked to provide information to verify their identity for a range of reasons, from borrowing a library book to staying in a hotel room. Traditionally, to provide verifiable identity information it has been necessary to produce one or more officially issued forms of identification, such as a passport or identity card, generally including at least a photograph of the person, and often other biometrics relating to the person. Often, different service providers will each issue a unique identity card to a user, each identity card only relevant to a particular service provider, and the user may be required to carry a large number of such cards for the various services to which they subscribe.

In recent years, there has been interest in enabling mobile phones to act as ‘digital wallets’ whereby credit card details may be stored in a secure area of memory on a mobile device and the mobile device used to make payments by wireless communication with a receiver using the NFC (Near Field Communications) standard. This allows payments to be made by simply waving the mobile device over a reader, avoiding the need for the user to physically find and present their credit card.

However, currently there is no standardized way to exchange verified identity information using NFC enabled mobile devices. Furthermore, the number of devices currently available that support the NFC standard is very limited, and the vast majority of mobile devices in use today provide no support at all.

The embodiments described below are not limited to implementations which solve any or all of the disadvantages of known systems and methods of exchanging verified identity information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods and devices for providing a verified identity of an entity are described. In particular, but not exclusively, methods and devices for providing a verified identity of an entity stored on a mobile device associated with the entity are described.

The preferred features may be combined as appropriate, as would be apparent to a skilled person, and may be combined with any of the aspects of the invention.

### BRIEF DESCRIPTION OF THE DRAWINGS

Embodiments of the invention are further described hereinafter by way of example only with reference to the accompanying drawings, in which:

FIG. 1 provides an overview illustration of an example system;

FIG. 2 is an example sequence diagram of data exchange between system entities;

FIG. 3 illustrates an example method performed by a mobile device;

FIG. 4 illustrates an example method performed by a guard device; and

FIG. 5 provides an overview illustration of a system.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

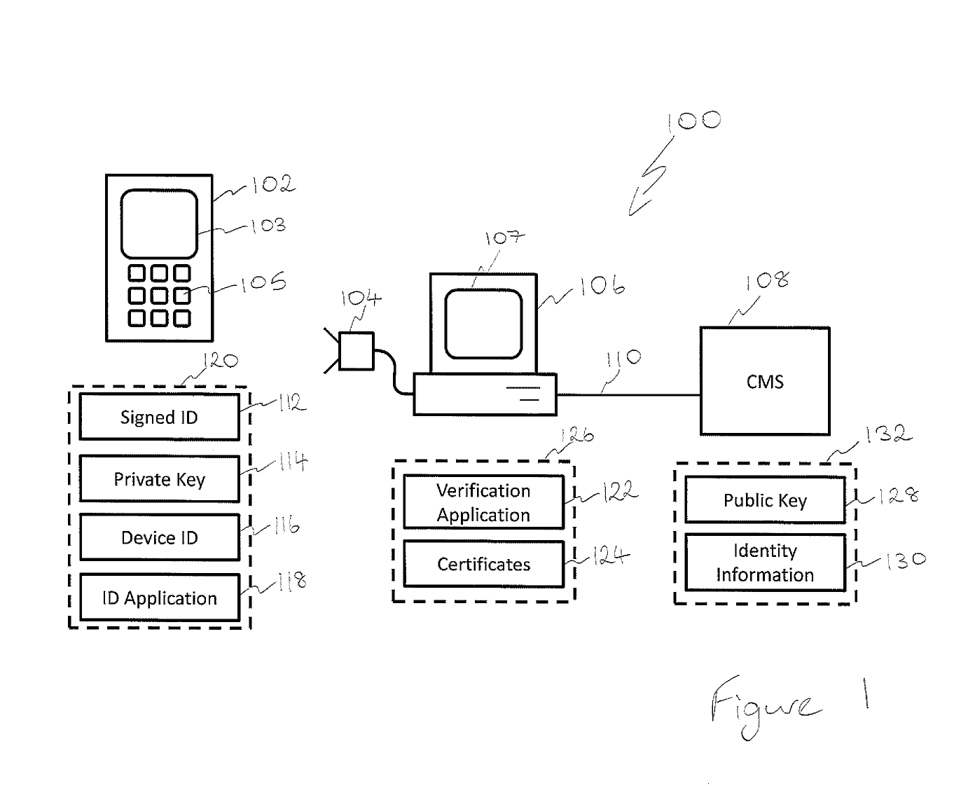

FIG. 1 illustrates a system 100 suitable for implementing embodiments described herein. The system 100 comprises a mobile device 102, a camera 104, a guard device 106, a credential management system (CMS) 108, and a network connection 110.

The mobile device 102 is associated with an entity of the system, and may for example comprise a mobile telephone owned by a person. The mobile device 102 includes a memory 120 and is pre-provisioned with information 112 that represents the identity of the entity associated with the mobile device 102, and also with a private key 114, of a public/private key pair. The mobile device 102 also stores a unique device ID value 116 that allows the device to be identified, for example an IMEI value associated with the mobile device 102.

The mobile device 102 comprises input means 105, such as a keyboard, which may comprise a physical keyboard or one displayed on a touchscreen interface, along with a display screen 103 and includes a processor (not shown) capable of executing an ID application 118 stored in the memory 120 of the device.

The information representing the identity of the entity may itself be cryptographically signed to ensure the integrity of the identity information. According to embodiments, the signing key pair used to sign the identity information may have an associated x.509 digital certificate that can be used to verify the authenticity of the key issuing system.

The mobile device 102 may be any type of mobile device. In particular, although not exclusively, the mobile device 102 may be any of a mobile telephone, a smart phone, personal digital assistant, tablet computer, or the like. In some embodiments, the mobile device 102 includes a software module or component. The software module may be a Java applet which is stored on the mobile device prior to executing a method according to an embodiment described herein. The software module may be provided as part of the firmware of the mobile device 102 or may be downloaded to the mobile device 102 via a network connection, for example from an application store i.e. a repository of applications.

The guard device 106 is coupled to camera 104 to allow images to be captured by the guard device 106 via the camera 104. The guard device 106 is further coupled to the credential management system 108 via network 110. The guard device 106 typically includes a display screen 107 and input means, and is provided with a verification application 122 stored in a memory 126 on the guard device 106. The guard device 106 may be pre-provisioned with cryptographic data to allow communications between the guard device 106 and the credential management system 108 to be adequately secured.

Although the guard device 106 has been shown in FIG. 1 as a desktop computer, it will be recognized that embodiments described herein are not restricted in this respect. The guard device 106 may be any type of processing device able to execute the verification application 122 and communicate with the client management system 108 via the network 110. For example, the guard device 106 may comprise a computer kiosk (or similar point of sale or access control equipment), or alternatively the guard device could comprise a further mobile device similar to the mobile device 102, but configured to execute a verification application.

In FIG. 1, the network connection 110 has been shown as a single entity, for example the Internet. However, it is envisaged that in some embodiments, the network connection 110 will comprise a plurality of communications networks. For example, it is envisaged that the guard device 106 will communicate data with the CMS 108 via one or more computer networks, such as over an IP protocol, and/or via a mobile communication network, such as GPRS, GSM, UMTS, WiMAX, or the like.

The CMS 108 stores a copy of the pre-provisioned identity information 130 relating to the mobile device 102, along with a public key 128 associated with the private key 114 stored on the mobile device 102. The CMS 108 may be configured to store identity and associated key data for a number of mobile devices registered to provide identity information.

Identity data and the public/private key pair used to verify the identity of the entity must be pre-shared between the mobile device 102 and the CMS 108, preferably but not necessarily via a trusted or secure channel. For example, registration of a mobile device 102 with the CMS 108 may require that the mobile device and user physically attend a suitable registration office to provide the required identity data for the user entity, and to provision the private key onto the mobile device 102. During such an enrolment, other biometric data relating to the user entity may be captured and stored on the CMS 108, such as a photograph or fingerprint. For less secure applications, it may be possible to provision such data via an encrypted network channel, or some other known method.

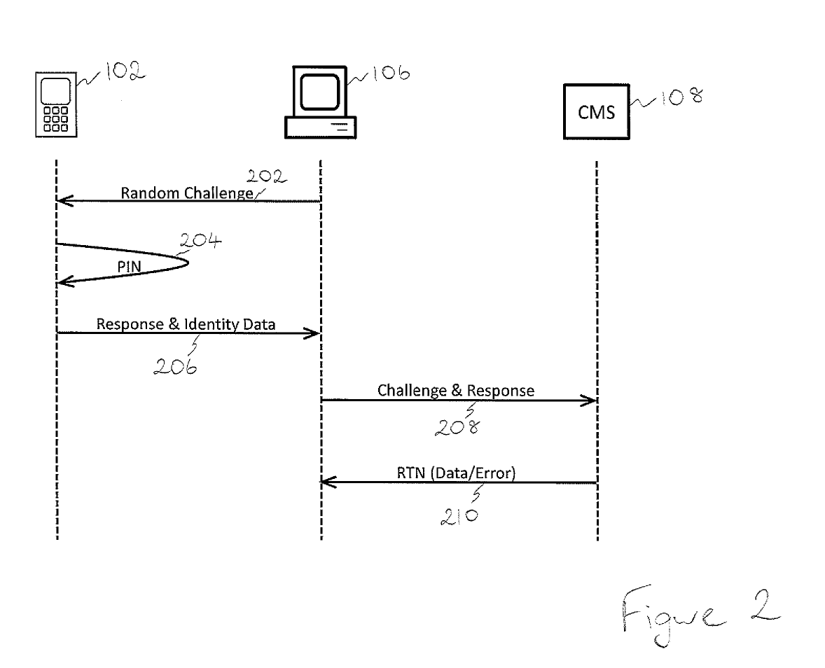

FIG. 2 illustrates a sequence diagram of a method of providing a verified identity using the mobile device 102. In the method illustrated in FIG. 2, the identity verification procedure starts with a random challenge 202 being presented to the mobile device 102 by the guard device 106. The random challenge 202 comprises a short sequence of characters that is displayed on the screen of the guard device 106 and that must be entered into the mobile device 102 by the user via a keyboard or equivalent input means of the mobile device.

The user then enters a personal identification number, or PIN code 204, to the mobile device before the ID application 118 will continue with the verification procedure. The use of the PIN code 204 provides proof of ownership of the device, tying the user to the mobile device 102.

The ID application 118 executing on the mobile device 102 then cryptographically processes the received random challenge 202 using the private key 114 to generate a response value.

A graphical representation of information including the response value, the device ID 116 and the identity information 112 of the user entity is then displayed on the screen 103 of the mobile device 102. For example, this graphical representation may comprise a QR-code, barcode, or other visual datagram.

The verification application 122 executing on the guard device 106 captures the displayed graphical representation 206 using the camera 104, and proceeds to decode the information contained within the graphical representation. Thus, the guard device 106 obtains from the mobile device 102: signed ID information 112 relating to the user entity; a device ID 116; and the response value generated using the private key 114 stored on the mobile device 102.

The guard device 106 transmits the random challenge value along with the response over network connection 110 to the credential management system 108 in message 208.

The CMS 108 has stored in memory 132 the public key 128 corresponding to the private key 114 of the mobile device. Thus, the CMS 108 is able to apply an inverse cryptographic algorithm to the response value using this public key 128 to recover the challenge 202. If the challenge value is successfully recovered from the response value, then the response value must have been generated using the private key 114, and therefore the identity of the mobile device 102 is verified, and the CMS 108 returns an indication of successful authentication to the guard device 106. However, if the correct challenge value is not recovered, then the identity of the mobile device cannot be authenticated and an error value is returned to the guard device 106.

According to some embodiments, the CMS 108 may supply further identity information to the guard device 106 upon a successful authentication of the mobile device 102. For example, the CMS 108 may return a copy of the signed entity identity data identical to the ID information 112 stored on the mobile device 102. Optionally, further information may be supplied such as a photograph of the user, or other biometric information, to allow a further check of identity to be made by the guard operating the guard device 106.

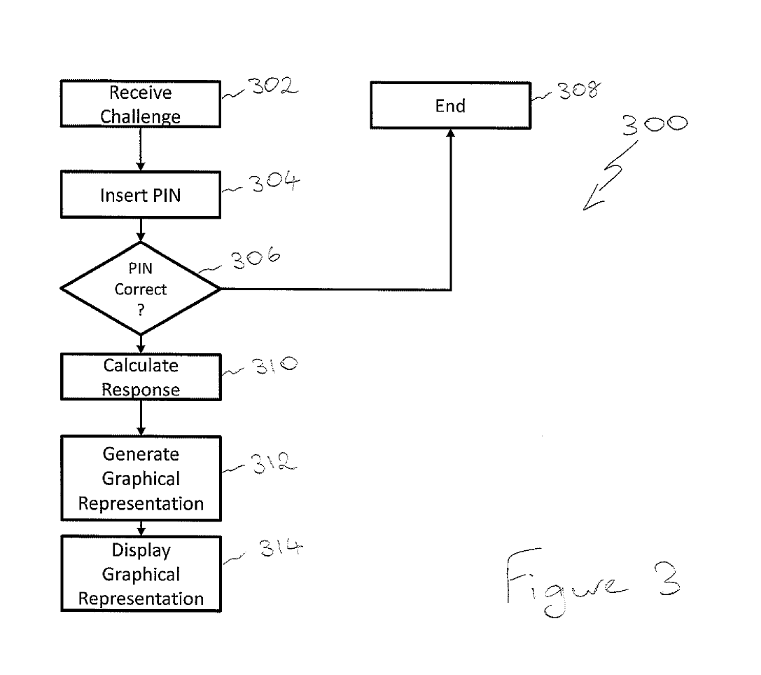

FIG. 3 illustrates a method 300 performed by an identity application 118 executing on the mobile device 102. As shown in FIG. 3, the method 300 comprises receiving a random challenge value at step 302, and then receiving a PIN value from a user of the device at step 304. The PIN value that has been input in step 304 is then checked in step 306. If an incorrect PIN number is input the method ends at step 308, however if the PIN number is correct the method continues at step 310 with the cryptographic processing of the challenge received challenge value using the private key 114 stored on the mobile device to determine a response value. At step 312 a graphical representation of the Signed ID information 112, the Device ID 116 and the response value is generated, for example in the form of a two-dimensional barcode. This graphical representation is then display on a screen of the mobile device 102 at step 314, to allow the information to be read by the guard device 106 using the camera 104.

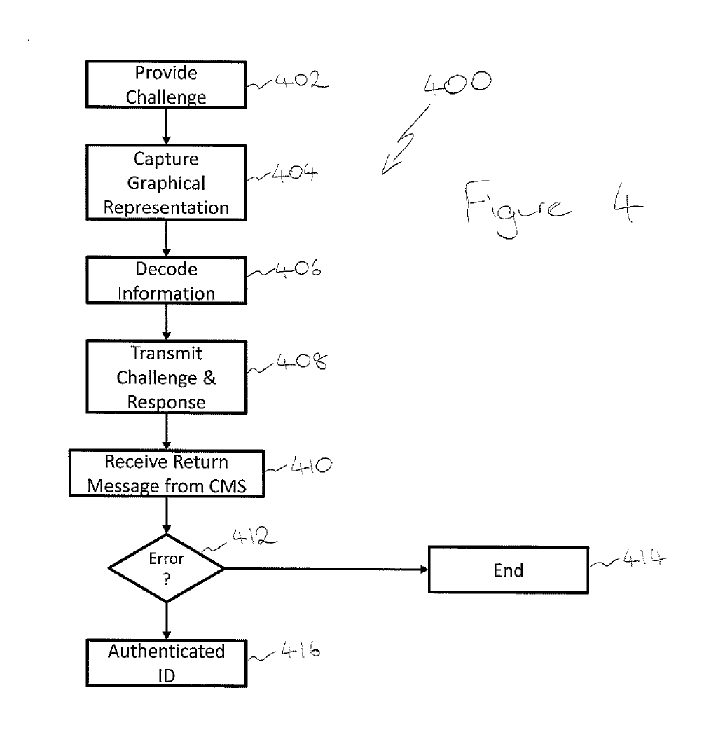

FIG. 4 illustrates a method 400 performed by the verification application 122 executing on the guard device 106. At step 402, the method begins by the guard device 106 providing a random challenge value to be input into the mobile device 102. As described above, the random challenge comprises a short sequence of characters. The guard device 106 then captures the graphical representation of information, generated in response to the challenge value by the mobile device 102, using the camera 14 at step 404. The information held by the graphical representation is then decoded at step 406 to recover the signed ID information 112 relating to the user entity associated with the device, the device ID 116 of the mobile device 102 and a response value based on the challenge and the private key 114 stored on the mobile device 102.

Having recovered the information from the graphical representation, the verification application 122 transmits the challenge value, along with the response value received from the mobile device, to the CMS 108 via network connection 110. The challenge and response values are processed by the CMS 108 and a return message is received by the verification application at step 410. The verification application 122 then determines whether the return message indicates an error, or exception, indicating that authentication of the mobile device 102 by the CMS 108 has failed at step 412, and if so the method ends at step 414. However, if an error is not indicated in the return message from the CMS 108, the authentication of the mobile device 102 and therefore the verification of the identity of the user entity is completed in step 416.

Upon successful verification of the user entity's identity, the guard device will display the entity identity information present in the signed ID 112 information provided by the mobile device 102. The displayed information will therefore provide an operator of the guard device 106 with a verified identity for the user presenting the mobile device 102.

According to embodiments, the CMS 108 may return further identification information to the guard station 106 upon successful authentication of the mobile device 102. For example, the CMS 108 may provide a stored digital photograph of the user associated with the mobile device to the guard station 106 to allow a guard to perform a further visual identification of the user of the mobile device. Other biometric data could also be provided, such as fingerprint information, depending upon the level of authentication required.

According to some embodiments, the guard device 106 is pre-provisioned with authorized certificates that can be used to verify whether the signature of the signed ID 112 information has been issued by a trusted issuer, such that trust in the data integrity of the signed ID 112 (and the signature itself) depends from a trusted root certificate, for example in accordance with the X.509 standard. Thus, according to this embodiment, the guard device 106 is able to verify the identity information 112 without communication with the CMS 108.

Optionally, the verification application 122 executing on the guard device 106, having verified the signature of the signed ID information, may continue to forwarding the challenge and response information to the CMS 108 for further checking If the signature cannot be verified against the authorized certificates, the verification application 122 may determine that the entity identity information provided is suspicious and terminate the verification procedure immediately, avoiding unnecessary use of network resources.

According to further embodiments, the guard device 106 may receive a public key associated with the mobile device 102. The public key value can then be used to verify the response and/or the integrity of the identity data. The public key may be provided by the CMS 108, or alternatively the public key could be received from an unsecure source, including the mobile device 102 itself, and then through communication between the guard device 106 and the CMS 108 the authenticity of the public key as being associated with the mobile device 102 can be determined.

The above described embodiments have been described as using a graphical representation such as a two-dimensional barcode to transfer data from the mobile device 102 to the guard device 106 via the camera 104. It will be understood that such graphical representations are not limited to two-dimensional barcodes, but could comprise one or more of a one-dimensional barcode, two-dimensional barcode, human readable text read into the guard device using optical character recognition (OCR), or the like. For example, some or all of the identity information could be displayed in human readable form on the mobile device 102 and read into the guard device 106 using OCR, while any remaining information is made available in barcode format.

Similarly, while in the described embodiment the random challenge value is input to the mobile device 102 using a keyboard or similar input device, it will be recognized that the random challenge value could be encoded into a graphical representation displayed on a screen of the guard device and read by the mobile device using a camera provided with the mobile device 102.

According to some embodiments, the identification information 112 stored on the mobile device need not be signed to ensure it is reproduced authentically. In this embodiment, identification information provided by the CMS 108 is displayed on the guard device 106 as the CMS 108 is considered a trusted source for identity information.

Alternatively, the guard device 106 may receive unsigned identification information from the mobile device and generate a hash value of the identification data using a cryptographic hash algorithm. This hash value is then transmitted to the CMS 108 over the network 110, along with the challenge and response information. As the identity information stored at the CMS 108 should be identical to that provided by the mobile device 102, the CMS is able to determine whether the hash value has been generated from correct identity information and thereby verify the unsigned identity information received by the guard device 106.

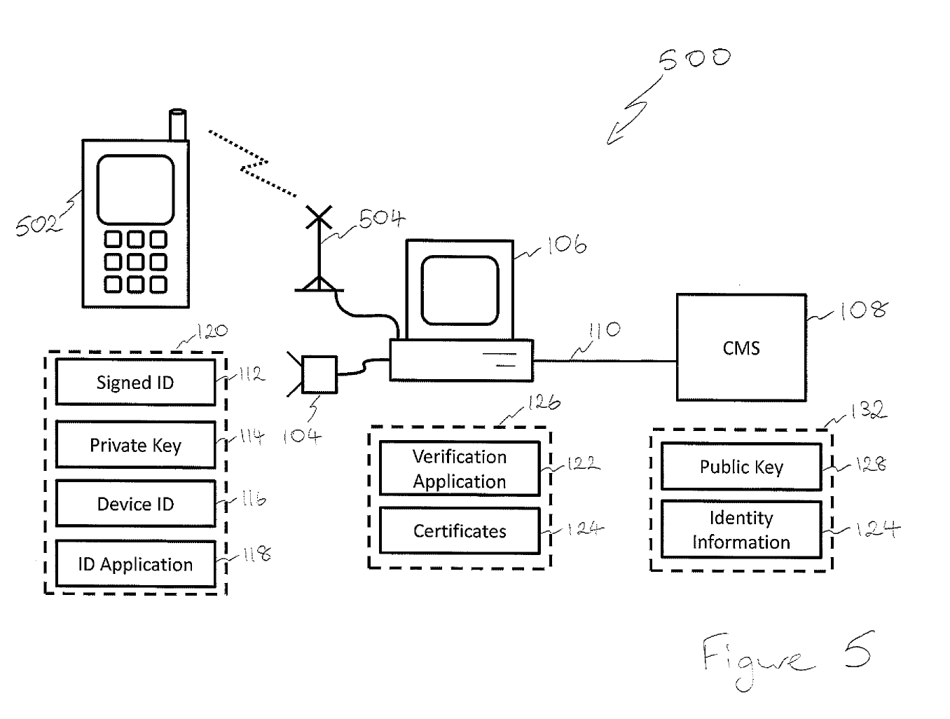

FIG. 5 illustrates a further embodiment, similar in operation to the embodiments described above, but which does not rely on a graphical representation of the response and identification data. In the embodiment of FIG. 5, mobile device 502 and guard device 106 are provided with an alternative communication interface, for example the devices may be able to communicate using one or more of the Near Field Communication (NFC), Bluetooth, WiFi, and infrared data association (IrDA) standards or via a wired connection. Transfer of data between the mobile device and the guard device can therefore be accomplished over the alternative interface, and it is not necessary to generate a graphical representation of the data.

Thus, according to the embodiment of FIG. 5, the mobile device 502 generates a response value by cryptographically processing the challenge value using the private key 114, as before, and then transmits the response value along with the signed identification information 112 to an interface 504, such as a wireless interface, of the guard device 106. The identity verification process then proceeds as described above.

The embodiment of FIG. 5 may facilitate quicker implementation of the method, at the expense of requiring increased functionality to be provided by the mobile device 102. It is envisaged that in some embodiments guard devices 106 may be implemented with various interface types, as well as with a camera, to allow the guard device 106 to implement both graphical and alternative methods of data exchange according to the abilities of the mobile device 102.

It will be appreciated that embodiments can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of tangible machine-readable storage that are suitable for storing a program or programs that, when executed, implement embodiments of the present invention. Accordingly, embodiments provide a program comprising code for implementing a system or method as claimed in any preceding claim and tangible machine readable storage storing such a program. Still further, embodiments of the present invention may be conveyed electronically via any medium such as a communication signal carried over a wired or wireless connection and embodiments suitably encompass the same. However, tangible machine-readable storage media do not include such communication signals.

Further aspects are set out in the following paragraphs:

According to a first aspect, there is provided a method of providing verifiable identity information using a mobile device, the method comprising receiving a challenge value, from a guard device, at the mobile device, generating a response value based on the challenge value and a private key associated with the mobile device, and providing the response value and identity information to the guard device.

Providing the response value and the identity information to the guard device may further comprise generating a graphical representation of the response value and the identity information and displaying the graphical representation. The graphical representation may comprise a barcode.

Providing the response value and the identity information may comprise generating a barcode comprising the response value, and displaying the barcode with human readable identification data.

The barcode may comprise a two-dimensional barcode.

Providing the response value and identity information to the guard device may further comprise transmitting the response value and identity information via a network interface.

The network interface may comprise at least one of: an NFC interface, a Bluetooth interface, a Wi-Fi interface, an Ir-DA interface, and a wired interface.

According to some embodiments, the method further comprises requiring entry of a personal identification number to the mobile device by a user of the mobile device before generating the response value.

Receiving the challenge value may comprise receiving a challenge value entered using a keyboard of the mobile device. Alternatively, receiving the challenge value mat comprise decoding an image of a barcode captured from a display of the guard device.

Generating the response value may comprise applying a cryptographic process to the challenge value using the private key and providing the response value and the identity information to the guard device may further comprise providing a device ID value associated with the mobile device to the guard device.

According to a further aspect, there is provided a mobile device for providing verifiable identity information, the device comprising input means for inputting challenge information to the mobile device, means for generating a response value based on the challenge value and a private key associated with the mobile device, and means for providing the response value and identity information to a guard device.

The input means may comprise a keyboard for entering the challenge value into the mobile device. Alternatively, the input means may comprise a camera for reading a barcode representation of the challenge value.

The means for providing the response value and the identity information to the guard device may comprise means for generating a graphical representation of the response value and the identity information and means for displaying the graphical representation.

The means for providing the response value and the identity information to the guard device may comprise a network interface. The network interface may comprise at least one of: an NFC interface, a Bluetooth interface, a Wi-Fi interface, an Ir-DA interface, and a wired interface.

According to a further aspect, there is provided a method of verifying received identity information comprising providing a challenge value to a mobile device, receiving a response value and identity information from the mobile device, transmitting the challenge value and the response value to a credential management system, and receiving an indication of authenticity of the response from the credential management system.

Receiving the response value and identity information may comprise capturing an image of a graphical representation of the response value and the identity information and decoding the graphical representation. The graphical representation may comprise one of: a one-dimensional barcode; a two-dimensional barcode; or a visual datagram.

Receiving the response value and identity information may comprise receiving the response value and identity information using a network interface. The network interface may comprise at least one of: an NFC interface, a Bluetooth interface, a Wi-Fi interface, an Ir-DA interface, and a wired interface.

The received identity information is signed and wherein the method may further comprise verifying the signature against authorized certificates stored in the guard device.

Receiving an indication of authenticity of the response may further comprise receiving a copy of the identity information from the credential management system.

According to a further aspect, there is provided a guard device for verifying received identity information, the guard device comprising means for providing a challenge value to a mobile device, means for receiving a response value and identity information from the mobile device, means for transmitting the challenge value and the response value to a credential management system, and means for receiving an indication of authenticity of the response from the credential management system.

The means for receiving the response value and identity information may comprise a camera for capturing an image of a graphical representation of the response value and identity information. The graphical representation may comprise one of a one-dimensional barcode, and a two-dimensional barcode.

The means for receiving the response value and identity information may comprise a network interface. The network interface may comprise at least one of: an NFC interface, a Bluetooth interface, a Wi-Fi interface, an Ir-DA interface, and a wired interface.

According to a further aspect, there is provided a computer program product comprising computer program code configured when executed on a processor to cause a mobile device to perform a method as described above.

According to a further aspect, there is provided a computer program product comprising computer program code configured when executed on a processor to cause a guard device to perform a method as described above.

According to a further aspect, there is provided a system for verifying identity information associated with an entity, the system comprising the mobile and the guard device, the system further comprising a credential management system configured to store a public key corresponding to the private key associated with the mobile device, the credential management system further configured to apply a cryptographic process to the response value using the public key, and to compare the result of the cryptographic process with the challenge value.

Some of the embodiments described herein may enable the provision of verified identity information relating to an entity associated with a mobile device.

Some embodiments described herein may provide a method of exchanging verified identity information that is applicable to legacy devices that are not compatible with one or more short range wireless communications standards.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments and the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

We claim:

1. A method of verifying received identity information, the method comprising:
providing a challenge value to a mobile device;
receiving a response value and identity information from the mobile device at a guard device using an NFC (Near Field Communication) interface, the identity information identifying a user of the mobile device;
determining the authenticity of the response; and
if the response has been successfully authenticated, displaying the identity information on a display screen of the guard device to provide an operator with verified identity information for the user.

2. The method of claim 1, wherein the received identity information is signed and wherein the method further comprises verifying the signature against authorized certificates stored in the guard device prior to displaying the identity information.

3. The method of claim 1, wherein determining the authenticity of the response comprises:
transmitting the challenge value and the response value from the guard device to a credential management system;
receiving at the guard device an indication of authenticity of the response from the credential management system; and
determining whether the indication of authenticity of the response indicates successful authentication.

4. The method of claim 3, wherein receiving an indication of authenticity of the response further comprises receiving a copy of the identity information from the credential management system.

5. The method of claim 1, wherein determining the authenticity of the response comprises verifying the response at the guard device using a locally stored public key associated with the mobile device.

6. The method of claim 1, further comprising receiving input at the guard device indicating the user of the mobile device has been visually identified using the displayed identity information.

7. A guard device for verifying received identity information, the guard device comprising:
means for providing a challenge value to a mobile device;
an NFC (Near Field Communication) interface for receiving a response value and identity information from the mobile device, the identity information identifying a user of the mobile device;
a verification application for determining the authenticity of the response; and
a display screen for displaying the identity information if the response has been successfully authenticated to provide an operator with verified identity information for the user.

8. The guard device of claim 7, wherein the received identity information is signed and wherein the guard device further comprises means for verifying the signature against authorized certificates stored in the guard device prior to displaying the identity information.

9. The guard device of claim 7, wherein determining the authenticity of the response comprises:
transmitting the challenge value and the response value from the guard device to a credential management system;
receiving at the guard device an indication of authenticity of the response from the credential management system; and
determining whether the indication of authenticity of the response indicates successful authentication.

10. The guard device of claim 9, wherein the indication of authenticity comprises a copy of the identity information from the credential management system.

11. The guard device of claim 7, wherein determining the authenticity of the response comprises verifying the response at the guard device using a locally stored public key associated with the mobile device.

12. The guard device of claim 7, further comprising input means for receiving input indicating the user of the mobile device has been visually identified using the displayed identity information.

13. A computer program product comprising computer program code configured when executed on a processor to cause a guard device to perform the method comprising:
providing a challenge value to a mobile device;
receiving a response value and identity information from the mobile device at a guard device using an NFC (Near Field Communication) interface, the identity information identifying a user of the mobile device;
determining the authenticity of the response; and
if the response has been successfully authenticated, displaying the identity information on a display screen of the guard device to provide an operator with verified identity information for the user.

14. The computer program product of claim 13, wherein the received identity information is signed and wherein the method further comprises verifying the signature against authorized certificates stored in the guard device prior to displaying the identity information.

15. The computer program product of claim 13, wherein determining the authenticity of the response comprises:
transmitting the challenge value and the response value from the guard device to a credential management system;
receiving at the guard device an indication of authenticity of the response from the credential management system; and
determining whether the indication of authenticity of the response indicates successful authentication.

16. The computer program product of claim 15, wherein receiving an indication of authenticity of the response further comprises receiving a copy of the identity information from the credential management system.

17. The computer program product of claim 13, wherein determining the authenticity of the response comprises verifying the response at the guard device using a locally stored public key associated with the mobile device.

18. The computer program product of claim 13, wherein the method further comprises receiving input at the guard device indicating the user of the mobile device has been visually identified using the displayed identity information.
